(19) United States
(12) Patent Application Publication
(10) Pub. No.: US 2006/0207410 A1
(43) Pub. Date: Sep. 21, 2006

(54) Cup and cup-like container

(75) Inventors: Yong-Soo Kim, Busan-Si (KR); Tae-Uk Nam, Busan-Si (KR)

Correspondence Address: ARENT FOX PLLC, 1050 CONNECTICUT AVENUE, N.W., SUITE 400, WASHINGTON, DC, 20036, US

(73) Assignee: Sungeum Hitech Co., Ltd.

(21) Appl. No.: 11/083,898

(22) Filed: Mar. 21, 2005

(51) Int. Cl. G10H 1/00

(52) U.S. Cl. 84/600

(57) ABSTRACT

A cup-like container made of one or more of a plurality of materials. A sensor unit is provided for sensing a conducting current caused by a specific resistance depending on a state and component of contents that are filled into the container. A circuit unit is provided for storing melodies and sound selected by a user. A power source is provided. A speaker is placed in an inner portion of the container and adapted to use a thin metal piece as part of a vibration device. In this manner, the user is informed of the sate or component of the contents by issuing at least one of music, melody and voice, which are stored in the circuit unit and desired by the user, through the speaker according to a signal from the sensor unit.

### BACKGROUND OF THE INVENTION

1. Field of the Invention

The present invention relates to a cup and a cup-like container (hereinafter, designated as “cups”), in which the cups have a single or double-walled structure, a predetermined space is formed to fit the elements of a product regardless of the material of the cups, and sensors, and a record-only chip and a music-only chip are placed in the lower end portion or lid of the cups, so that the cups provide a user with previously stored music or previously recorded personal voice so as to inform the user of the state and component of contents contained in the cups.

2. Description of the Related Art

Cups, which are generally sold, are manufactured to have single or double-walled structures, as shown in FIGS. 1, 2 and 3. In more detail, cups having double-walled structures, include metallic double-walled cups, plastic double-walled cups, and cups manufactured by coupling inner and outer parts that are made of metal and plastic, respectively. In contrast, cups having single-walled structures include cups that are manufactured of metal, plastic, ceramic, porcelain and the like.

The cups are differently manufactured in terms of size and shape according to purpose. They may be used to lengthen the time for which the warmth and coldness of beverages can be maintained using lids. The chief function of the cups is merely to contain beverages for a short period and allow users to drink the beverages.

The internal temperatures of cups are not generally sensed by users. In the case of double-walled cups, the internal and external temperatures thereof are different from each other because internal heat is not transferred to the outsides of the cups well. Accordingly, the case where a user suffers burns by mistake occurs frequently. Furthermore, in the case of the single-walled cups, there are cases where the high heat of the cups surprises users while they try to grasp them.

Furthermore, in the case of metal and opaque cups, since users cannot sense to what extent the cups are filled with contents, there are cases where contents overflow the cups while the contents are poured into the cups.

To overcome the disadvantages and the simple functions as described above, the present invention provides cups, which are called super magic cups, which can delight users when the cups are used and are most visually and audibly pleasing. The cups of the present invention have the following characteristics.

When the cups are filled with beverages and a predetermined temperature is reached, they inform users that the contents thereof have reached a certain temperature using sweet and soft music, melody or voice. Furthermore, the cups allow music play such that the users are yet more delighted and relieved when using them.

Meanwhile, the present invention may be adopted to cups that are combined with a straw, which are manufactured for children's use. In this case, when the children drink health beverages for their growth using the cups combined with straws, they provide music to the children according to a specific beverage or the concentration of the beverages. Accordingly, the children can use them with delight.

### SUMMARY OF THE INVENTION

Accordingly, the present invention has been made keeping in mind the above problems occurring in the prior art, and an object of the present invention is to provide a cup-like container, which provide a user with previously stored music or previously recorded personal voice so that the user is informed of the state and component of contents in the cup-like container, in which the cup-like container has a single or double-walled structure, a predetermined space is formed to fit the elements of a product regardless of the material of the cup-like container, and sensors, a record-only chip and a music-only chip are placed in the lower end portion or lid of the cup-like container, so that, when the first control sensor of a control unit transmits a signal to the music-only chip after performing sensing operations according to the use thereof, the users' desire, the temperature, conducting resistance and characteristic concentration of the contents or specific components contained in the contents, a power source is connected to a circuit unit storing music, the circuit unit is operated and, therefore, the stored music is issued, and in which the record-only chip is constructed such that personal voice besides previously stored music and voice is stored therein, and the second control sensor is placed such that the user can be informed of the internal temperature of the cup-like container and the amount and concentration of the contents and the issuance of sound can be selectively adjusted, and the location of a flow sensor or resistance sensor is changed so that the switch thereof is connected when the user wants, so that the issuance of the sound can be selected, personal voice can be recorded without inconveniencing others and the recorded voice and the stored music can be heard when desired, thus providing the user with pleasure and comfort.

In order to accomplish the above object, the present invention provides a cup-like container. In the case of double-walled structures, predetermined spaces are formed between the inner and outer parts of the cup-like container, respectively. In the case of metal, the double coupling portions of the inner and outer parts are jointed together by welding or double rolling. In the case of plastic, the inner and outer parts are assembled in a screw or an insertion fashion, so that the outward shape of a container is accomplished. In the case of a cup-like container employing a first sensor, a temperature sensor is placed as the first sensor so that a power source is connected or disconnected to a chip by sensing a temperature of contents, and melodies and music, which are stored, are emitted due to the first sensor when a sensed temperature reaches a predetermined temperature according to the users' desire. In the case of a cup-like container employing first and second sensors, a signal, which is conducted by a first sensor and caused by the inflow of the contents into the interior of the container, firstly allows the power source to be connected, a signal, which is conducted by the second sensor and caused by the leaning of the container, is secondly transmitted to an operation switch and, therefore, stored sounds or personally recorded voices are issued to the outside through sound holes.

A single-walled structure of a cup-like container manufactured using a variety of materials employs a first sensor or first and second sensors. In the case of a cup-like container employing the first sensor, a temperature sensor is placed as the first sensor so that a power source is connected or disconnected to a chip by sensing a temperature of contents using the first sensor, melodies and music, which are stored, are issued by sensing the flow of the contents. In the case of a cup-like container employing the first and second sensors, the first sensor senses temperature and conducting resistance caused by the contents which are poured into the cup-like container, and allows a circuit unit storing music to enter into an operation stand-by state by connecting a power source to it, and the second sensor is placed to sense the concentration of the contents and the user's intentional touch, and the circuit unit receives signals generated by the second sensor and allows sounds stored therein to be issued to the outside through a speaker and resonant holes.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a sectional view showing a conventional double-walled cup;

FIG. 2 is a sectional view showing a conventional plastic, metal or glass cup;

FIG. 3 is a sectional view showing a typical ceramic or porcelain coffee cup;

FIG. 4 is a sectional view showing a double-walled cup-like container according to the present invention;

FIG. 5 is a sectional view showing another double-walled cup-like container, which is manufactured such that a plastic or metal bottom is attached to and detached from a body, according to the present invention;

FIG. 6 is a sectional view showing another cup-like container having a sound-generating device, in which the metal inner and outer parts thereof are jointed together by double rolling, according to the present invention;

FIG. 7 is a sectional view showing another cup-like container having a sound-generating device, in which the inner and outer parts thereof are manufactured using a plastic material, according to the present invention;

FIG. 8 is a sectional view showing a lid, in which a sound-generating device is placed, according to the present invention;

FIG. 9 is a view showing the assemble of a lid, in which a sound-generating device is placed, and a body;

FIG. 10 is a sectional view showing another cup-like container having a double-walled structure, in which a sound-generating device is placed and the inner and outer parts thereof are made of plastic and metal, respectively, according to the present invention; and

FIG. 11 is a sectional view showing a coffee cup made of ceramic, in which a sound-generating device is placed, according to the present invention.

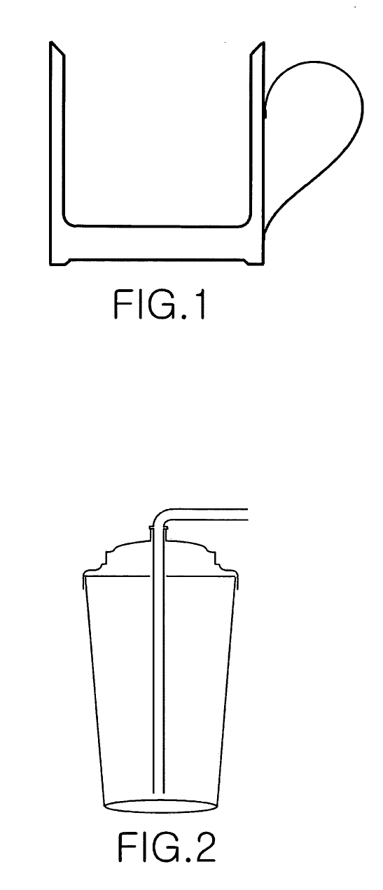

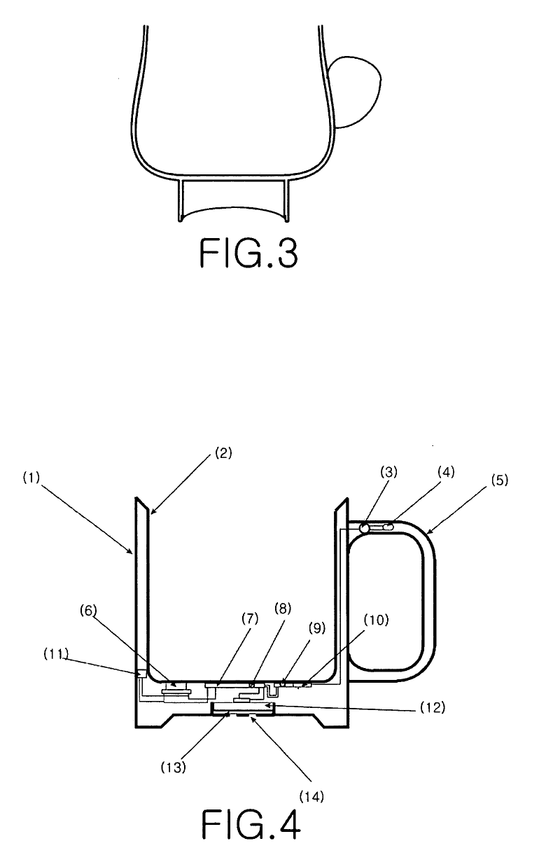

### DESCRIPTION OF THE PREFERRED EMBODIMENTS

Embodiments of the present invention are described in detail with reference to accompanying drawings below.

FIG. 4 is a sectional view showing a cup-like container in which the circuits and structure of the present invention are provided inside an integrated double-walled warmth-keeping body the inner and outer parts of which are entirely made of metal. The outer part 1 of the cup-like container having a double-walled structure and the inner part 2 of the cup-like container are coupled to each other by welding, so that a predetermined space is formed between the inner and outer parts 1 and 2. A record-only chip 9 and a music-containing chip 7 are connected to each other, and are allowed to be operated by a single power source. A record-only microphone 3 and a recoding microphone 4 are placed in a grip 5 and are connected to the output terminal of a record-only circuit board 10. A first temperature sensor 6 is placed under the interior of the cup-like container, and is connected to a first power source and an operation sensor. A flow sensor 11 is connected to the circuit of the music-containing chip 7 for the exclusive use of melody and voice, and is used as a second control sensor. A speaker 12 is placed on a waterproof part 14 having a resonance sound emission hole 13 and is connected to the output circuit unit of the music-containing chip 7.

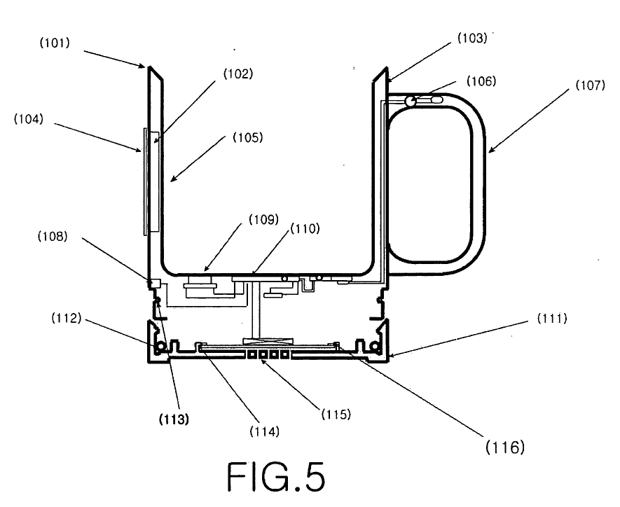

Referring to FIG. 5, the inner and outer parts of a cup-like container are made of metal, and are jointed together by welding. A concave groove 113 is formed in the lower end portion of the cup-like container and conforms to the plastic or metal bottom of the cup-like container by having a part of the lower end portion of the body cut out in a predetermined form. First and second sets of circuits and control sensor units identical to those of FIG. 4 are placed inside the end portion of the cup-like container. A conductor 102 is placed in a space between the inner and outer parts of the cup-like container. A temperature-variable paint 104 is applied on the outer part of the cup-like container, so that the shape of the applied paint can deform according to temperature variation. A rubber seal 112 is provided in the lower end portion of the cup-like container, thus waterproofing the bottom of the cup-like container and assembling it to the other parts of the cup-like body. To prevent external air from flowing into the bottom of the cup-like container, a rubber seal 116 is provided on the upper end of a speaker fastening part 114, and the output terminal of a music-containing chip 110 is connected to a speaker.

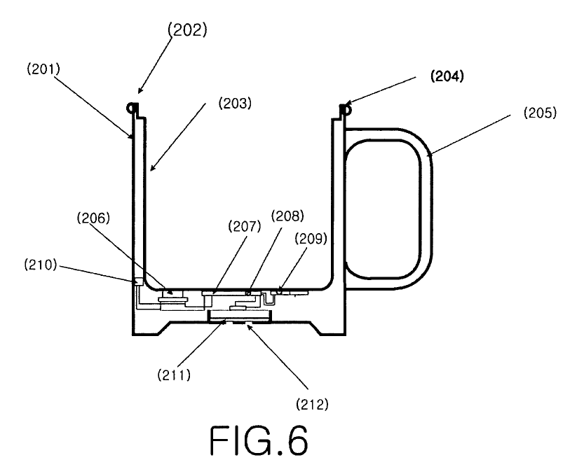

The cup-like container of FIG. 6 is placed using the same method as in FIG. 4. In FIG. 4, a method of joining the inner and outer parts of a cup-like container is performed by inserting the inner part into the outer part and simultaneously rolling the inner and outer parts.

The operation of the cup-like containers of FIGS. 4, 5 and 6 among the cup-like containers of the present invention is described in detail below.

A first operation is performed in such a way that each of the first control sensors 6, 109 and 206 for detecting the temperature of contents in each of the cup-like containers first detects the temperature of contents that are poured into each of the cup-like containers, and allows first power sources to be connected to the circuits of the chips 7, 110 and 207, respectively, so that previously stored music is issued to the outside through each speaker.

A second operation is performed in such a way that the individual chips 7, 110 and 207 enter into a power stand-by state by connecting power sources to the circuits of the chips 7, 110 and 207, respectively, when the first control sensors 6, 109 and 206 have sensed the temperature of the contents, and the second control sensors 11, 108 and 210 each sense the slight variation in resistance caused by currents conducted when the bodies are moved or when the users' lips touch the upper end portions of the bodies, and transmit a signal to operation switches of the circuits of the chips 7, 110 and 207, respectively, and, therefore, the sounds previously stored are issued. Furthermore, the present invention provides a recording function. For example, when a button 4 is pressed to record a user's voice, the user's voice is stored in the recording-only chip 9 via a microphone 3. In this case, when the contents are poured into the individual cup-like containers, a previously recorded voice is first issued to the outside. Accordingly, the recorded voice can be immediately reproduced after the recording is finished.

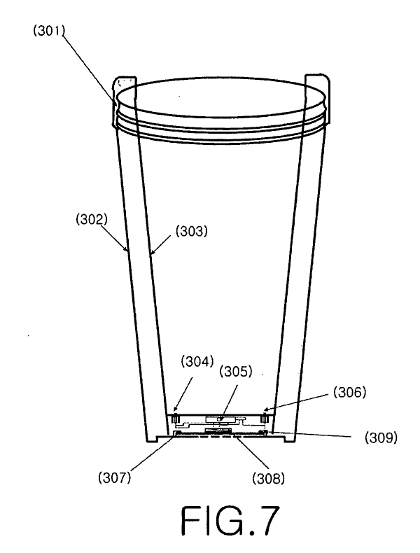

In the plastic double-walled cup-like container of FIG. 7, the inner part 303 and outer part 302 of the cup-like container are made of plastic, and are jointed together in a screw fashion. A conducting resistance sensor 306, that is, a first control sensor, is connected to a circuit 305 storing music and melodies, and a resistance sensor 304 for sensing variation in concentration and resistance is used as a second control sensor. The circuit unit 305 is connected to a speaker 308. The speaker 308 is placed on a waterproof part 307. A rubber seal 308 is disposed to block the inflow of external air.

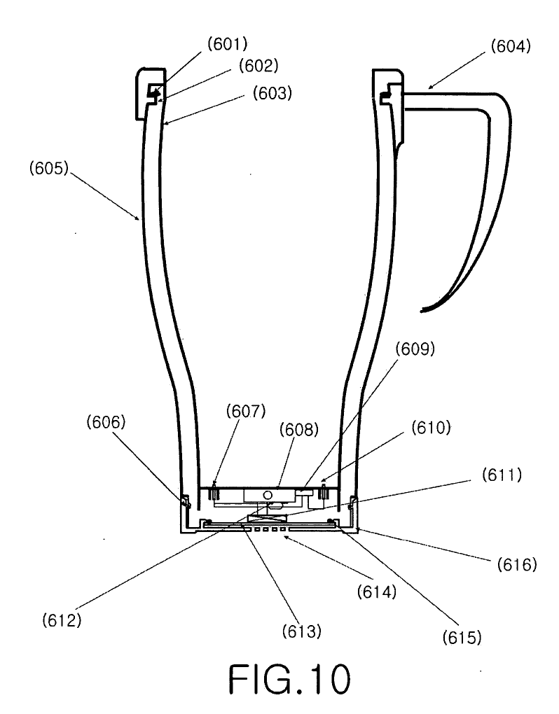

In the case of the cup-like container of FIG. 10 in which inner and outer parts 603 and 605 are made of plastic and metal, respectively, the inner and outer parts 603 and 605 are jointed with a fastening hole 602. The inner and outer parts 603 and 605 are sealed using a waterproof rubber seal, and then the inner and outer parts 603 and 605 are assembled with each other. An interior structure is arranged in a space formed inside the inner plastic part 603 in the same way as in FIG. 7. Specifically, a sensor 601 for sensing conducting current caused by the inflow of contents is used as a first control sensor, and a sensor 607 for sensing variation in resistance is used as a second control sensor, and is connected to a circuit unit 608 containing a melody voice chip. The circuit unit 608 is connected to a speaker 611 that is placed in a resonance sound emission hole 614 and a waterproof part 613. The upper end portion of the speaker 611 is sealed by a rubber seal 615 to block the inflow of external air.

With reference to FIGS. 7 and 10, the operation of the double-walled cup-like containers in which the inner parts are made of plastic is described in detail below.

When contents are poured into the cup-like containers having the plastic inner parts, the first control sensors 306 and 610 generate signals according to the sensing of the contents and the second control sensors 304 and 607 then allow the circuit units 305 and 608 storing music to operate, so that music is issued through speakers 308 and 611. At the request of the user, the cup-like containers having double-walled structures may be constructed to be operated in such a way that power sources are connected to the circuit units 305 and 608 that contain music, respectively, by signals generated from the first control sensors 306 and 610, the circuit units 305 and 608 each enter into a stand-by state, second circuit switches are then closed when receiving signals caused by variation in resistance from the second control sensors 304 and 607, respectively and, therefore, the circuit units 305 and 608 operate and, therefore, the music stored in the circuit units 305 and 608 is issued to the outside through the speaker 308 and 611 secured to waterproof parts 308 and 613.

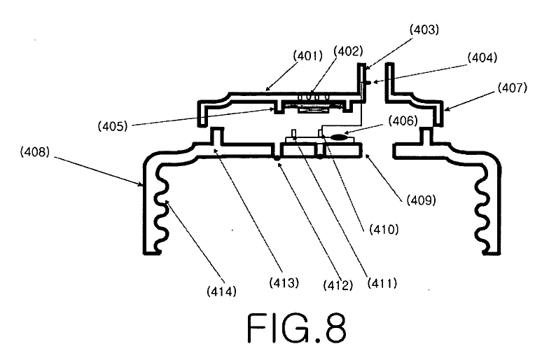

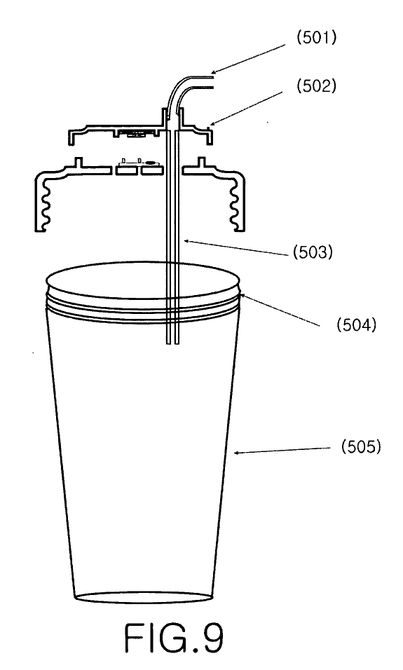

Referring to FIGS. 8 and 9, sound-generating devices are placed in lids, and a body 505 is molded in the form of a single-walled structure. A spiral part 504 is formed on the surface of the upper end portion of the body, and is formed to correspond to a spiral part 414 formed on the surface of the lower end portion of the lid of FIG. 8. The lid of FIG. 8 is divided into an upper end portion 401 and a lower end portion 408, and a predetermined space is formed between the two portions 401 and 408. A circuit unit 411, on which a chip 406 storing music is mounted, is coupled to a lower end portion 408 in the predetermined space, and a Light Emitting Diode (LED) 412 is coupled to a lower end portion 408 in the predetermined space and operates simultaneously with the sound of music. A waterproof part 405 is formed at the upper end portion of the lid, and a speaker is then coupled by the waterproof part 405. A straw is formed to be separated into an internally inserted straw 503 and an externally protruding straw 501. A sensor 404 for sensing a conducting current is placed within a hole 403 for fastening the externally protruding straw 501. A lower end portion fastening part 413 and an upper end portion fastening part 407 are coupled to each other.

The operation of the cup-like container exclusively for use with a straw is described in detail below.

Referring to FIG. 9, the body and the lid are assembled together. The externally protruding straw 501 is fitted into a fastening hole 403, and the internally inserted straw 503 is connected to the fastening hole 403 through the through hole 409 of the lower end portion of the lid. In this case, when contents flow into the connected straw, the internal sensing control signal of the sensor 404 is transmitted to the circuit unit 406, a power source is connected to the circuit unit 406 in response to the transmitted signal, the circuit unit 406 enters into a stand-by state, stored music is issued to the speaker by a sensing switch located on the opposite side of the circuit unit or in the outside, and the stored music is issued, so that it is possible to selectively listen to music. Furthermore, a plurality of switch pins may be disposed, and a plurality of pieces of music corresponding to the individual pins may be contained in the circuit unit, so that various pieces of music are selectively issued by touching the individual pins.

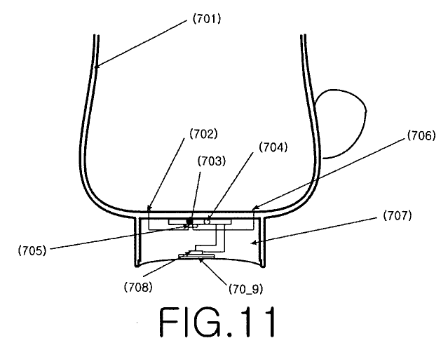

FIG. 11 is a sectional view showing a coffee cup made of ceramic, in which a sound-generating device is placed, according to the present invention.

A predetermined space 707 is formed in the lower end portion of the body of a coffee cup (or a bowl shape of a cup) made of ceramic. A sensor 706 for sensing a conducting current and a sensor 702 for sensing variation in resistance are placed in the formed space. The sensors 706 and 702 are used as first and second control sensors, respectively. A music-storing chip 703 is connected to a speaker 708 by the operation of the sensors 706 and 702. The speaker 708 is coupled to a waterproof part 709.

The operation of the cup made of ceramic is described in detail.

When contents are poured into the cup made of ceramic, the first and second control sensors 706 and 702 sense an internal temperature of the cup and variation in conducting resistance, respectively, and transmit signals to a circuit unit 704. Thereafter, the signals are transmitted to the music-containing chip 703 through a switch unit 705 detecting the signals, and music or melody stored in the chip 703 is emitted through the speaker 708 and is issued to the outside through the internal holes of the waterproof part 709. Accordingly, the users can listen to music or melodies when using the cup. Furthermore, the external surface of the cup is printed using paint, the color of which varies with an internal temperature. As a result, the users can drink beverages while simultaneously enjoying audible and visual effects.

As described above, in accordance with the present invention, since a first control method using the first control sensor and a second control method using the first and second control sensors are performed according to the contents of a cup-like container and the users' desire, power consumption caused by a stand-by current and natural discharge can be reduced.

Furthermore, at the time of the inflow of contents, the power source is connected due to the operation of the first control sensor, and the second control sensor operates in conformity with a conducting current reaction operation caused by a slight variation in resistance or concentration and by the physical properties of a specific beverage. Accordingly, information on the contents can be provided to users, the users can personally record thankful messages for a specific date, stored background music can be automatically played by operating a pulse conversion switch after finishing the recording, and children can enjoy listening to a selected sound without inconveniencing others because they can selectively listen to children's songs, melodies, parents' voices or the like while drinking milk, health beverages or the like. Furthermore, the present invention can be used for a business public relations (PR), and as a gift as a return favor at weddings and the like.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A cup-like container, the cup-like container being made of one or more of a plurality of materials (plastic, ceramic, glass, aluminum and stainless), comprising:
a sensor unit for sensing a conducting current caused by a specific resistance depending on a state and component of contents that are filled into the container;
a circuit unit for storing melodies and sound selected by a user;
a power source for supplying power; and
a speaker placed in an inner portion of the container and adopted to use a thin metal as part of a vibration device;
wherein the user is informed of the state or component of the contents by issuing at least one of music, a melody and a voice, which are stored in the circuit unit and desired by the user, through the speaker according to a signal from the sensor unit.

2. The cup-like container as set forth in claim 1, wherein the sensor unit comprises a temperature sensor as a first switch and a resistance sensor as a second switch, so that sound is issued in one of two mode, either by detecting a first switching signal corresponding to temperature according to opening and closing of the first switch, or by detecting a second switching signal corresponding to temperature and characteristics of contents according to opening and closing of the first and second switches.

3. The cup-like container as set forth in claim 1, wherein the cup-like container is made of any one selected from the group consisting of plastic and porcelain, and is configured to contain one or more switches that operate by detecting temperature or variation in resistance.

4. The cup-like container as set forth in claim 1, wherein the container is formed of a plurality of metallic parts and is manufactured by a rolling process, a space is formed between the metallic parts using a plastic holder, and the sensor unit is placed inside the space.

5. The cup-like container as set forth in claim 1, wherein the container comprises a body and a lid that are made of plastic or glass and the sensor unit is placed inside the lid.

6. The cup-like container as set forth in claim 1, wherein an inner part of the container is made of plastic and an outer part of the container is made of stainless.

7. The cup-like container as set forth in claim 1, wherein air emission holes having a predetermined size are formed in a lower portion of the container so that sound from the speaker is issued to the outside due to movement of air, a polyester film is mounted between an upper end portion of the holes and the speaker to amplify the movement of air, and the speaker is sealed using polymer adhesive after being fastened to an upper portion of the film, so that moisture and humidity are blocked, sound issued from the speaker is amplified and emission of the sound is facilitated.

8. The cup-like container as set forth in claim 1, wherein the container comprises a grip and a body, the grip and body of the container are covered by a waterproof cover, and a recoding microphone and a record button are placed inside the grip or the body, so that recording is performed by pressing the button.

9. The cup-like container as set forth in claim 1, wherein the container is constructed so that previously stored melody or sound is issued to the outside immediately after recorded contents are reproduced.

10. The cup-like container as set forth in claim 1, wherein the container is made of porcelain or ceramic in such a way that a predetermined space is formed in a lower portion of the container, a temperature sensor or conducting resistance switch is placed in the space, a space for amplifying sound is formed between the speaker and a polyester film in the lower portion of the container so that sound form the speaker is emitted to the outside and the emitted sound is amplified, and an upper end portion of the speaker is fastened and sealed so that the sound is issued to the outside.

11. The cup-like container as set forth in claim 1, wherein the container is separated into a body and a lid, the lid is separated into an upper end portion and a lower end portion, a predetermined space is formed between the upper and lower end portions, at least one pin made of a conductive material is exposed to the contents flowing into a straw, and a portion of the sensor unit is exposed to the outside so that the user can issue the sound from the speaker to the outside.

12. The cup-like container as set forth in claim 1, wherein a predetermined space is formed in the cup-like container, a chip containing music and voice sounds is placed in the formed space, and a first switch that operates in response to temperature and a second switch that operates in response to tilt of the cup-like container and a user's contact are included, so that sound is issued according to detection signals generated by operation of the first and second switches.

13. The cup-like container as set forth in claim 1, wherein the speaker is constructed so that the sound output from the circuit unit storing the sound and the melody resonates in a predetermined space and is output to the speaker, and a fastening unit for fastening the speaker is completely sealed so that air is circulated within the predetermined space, and only the sound is output to the outside through the speaker, thus blocking a natural discharge of the power source unit.

14. The cup-like container as set forth in claim 1, wherein at least one conductive pin is placed in a portion of the inner part of the container or a lid of the container so that the conductive pin senses a conducting current when the contents are poured into the cup-like container, such as a portion of a straw.

15. The cup-like container as set forth in claim 1, wherein the container is separated into a body and a lid, and the speaker is placed in a portion of the container.

16. The cup-like container as set forth in claim 1, wherein the container comprises a first switch placed inside the container to detect contact with contents, and a plurality of second switches inside a lid of the container to detect a user's contact, so that different types of sounds are generated according to the first and second switches.

17. The cup-like container as set forth in claim 1, where a temperature-variable material is printed on an outer part of the container and a heat conductor is placed in a predetermined space between outer and inner parts of the container, so that internal heat of the container is rapidly transferred to the outside and, therefore, a color of the temperature-variable material is allowed to vary with the transferred heat.

18. The cup-like container as set forth in claim 1, wherein an inner part of the container is made of a non-conducting material, such as plastic, so that the user can be informed of an appropriate level of contents via the voice or music when the sensor unit, which is placed at a predetermined position within an interior of the container, senses the level of the contents.

19. The cup-like container as set forth in claim 1, wherein the second control sensor is operated according to variation in resistance caused by an absence of contents, so that the user can be informed of the absence of contents via the voice or music.
